(19) United States
(12) Patent Application Publication
(10) Pub. No.: US 2014/0004915 A1
(43) Pub. Date: Jan. 2, 2014

(54) MOBILE PHONE CASING

(71) Applicant: Pei-Lin HUANG, New Taipei City (TW)

(72) Inventor: Pei-Lin HUANG, New Taipei City (TW)

(21) Appl. No.: 13/721,437

(22) Filed: Dec. 20, 2012

(30) Foreign Application Priority Data
Jul. 2, 2012 (TW) 101123707

(51) Int. Cl. H04M 1/02

(52) U.S. Cl. CPC H04M 1/0202
USPC 455/575.8

(57) ABSTRACT

A mobile phone casing in which a mobile phone is protectively held and positioned comprises a cover body and a locating base linking to each other: the locating base is provided with positioning measures for positioning a mobile phone; the cover body is provided with a fastening part at one side and an inclined folding line with one end higher than the fastening part's top edge and the other end lower than the fastening part's bottom edge.

### BACKGROUND OF THE INVENTION

1) Field of the Invention

The present invention relates to a mobile phone casing, particularly a mobile phone casing by which a mobile phone is protectively held and laid on a level table for observation of a user.

2) Description of the Prior Art

A variety of electronic devices (e.g., mobile phone, iPod, MP4, etc.) have been available in the market with technology fast developed. A consumer who deliberately prevents his/her electronic device from collision, abrasion or damage out of any unpredictable external force probably purchases a leather sheathe or case to externally protect the electronic device from damage.

Smart mobile phones mostly available in the market offer consumers diversified functions such as video, photo and music which are attainable from a mobile phone held in a consumer's hand rather than a mobile phone horizontally laid on a table because of an improper viewing angle which hurts the neck of a consumer who has laboriously watched it for a long period.

The present invention is intended for providing a mobile phone casing which overcomes drawbacks hereinbefore and difficulties in current technology.

### SUMMARY OF THE INVENTION

The present invention provides a device which depends on an inclined folding line at its cover body to lift one part of the cover body outward and makes a fastening part of the cover body laterally resisting the other part of the cover body so that a mobile phone is tilted on a level table at a visible angle of elevation and observed by a consumer.

The present invention provides a device in which a mobile phone is held and effectively prevent the mobile phone from collision or abrasion out of any external force.

The present invention provides a device with diversified characteristics such as simple structure, easy operation and high stability.

A mobile phone casing comprises: a locating base on which positioning measures are assigned for holding and positioning a mobile phone; a cover body with a first side edge and a second side edge on which there is a fastening part with a top edge and a bottom edge; an attachment linking the cover body's first side edge and the locating base as a whole; features as follows: the cover body is designed to have an inclined folding line located between the first side edge and the second side edge and including a first endpoint and a second endpoint wherein the first endpoint is higher than the top edge of the fastening part and the second endpoint is lower than the bottom edge of the fastening part so that the cover body is separated into a baseplate and a support plate.

In a preferred embodiment, the first endpoint and the second endpoint of the inclined folding line are near the second side edge and the first side edge, respectively.

In a preferred embodiment, the positioning measures are assigned to at least a clamping part around the locating base.

In a preferred embodiment, the positioning measures can be hook-and-loop fasteners.

In a preferred embodiment, the positioning measures can be reused viscous bodies.

In a preferred embodiment, the support plate is provided with fixing components corresponding to other fixing components on the locating plane of the locating base for holding and positioning a mobile phone.

In addition to the above structure, the present invention provides a mobile phone casing with an alternative structure: the cover body is designed to have an inclined folding line located between the first side edge and the second side edge and including the first endpoint and the second endpoint; both the first endpoint and the second endpoint are lower than the fastening part's bottom edge and the first endpoint is higher than the second endpoint so that the cover body is separated into a baseplate and a support plate.

In a preferred embodiment, the first endpoint and the second endpoint of the inclined folding line are near the second side edge and the first side edge, respectively.

In a preferred embodiment, the positioning measures are assigned to at least a clamping part around the locating base.

In a preferred embodiment, the positioning measures can be hook-and-loop fasteners.

In a preferred embodiment, the positioning measures can be reused viscous bodies.

In a preferred embodiment, the support plate is provided with fixing components corresponding to other fixing components on the locating plane of the locating base for holding and positioning a mobile phone.

The functions of the present invention are explained in embodiments and accompanying drawings as follows.

### BRIEF DESCRIPTIONS OF THE DRAWINGS

FIG. 1 is a perspective view for the present invention of a mobile phone casing which is unfolded;

FIG. 2 is a perspective view for the present invention of a mobile phone casing which is folded;

FIGS. 3A and 3B are schematic views of the mobile phone casing in operation;

FIG. 4 is a schematic view of the mobile phone casing in the other embodiment;

FIG. 5 is a schematic view of the mobile phone casing in a further embodiment; and

FIG. 6 is a schematic view of the mobile phone casing in a yet other embodiment.

### DETAILED DESCRIPTIONS OF THE PREFERRED EMBODIMENTS

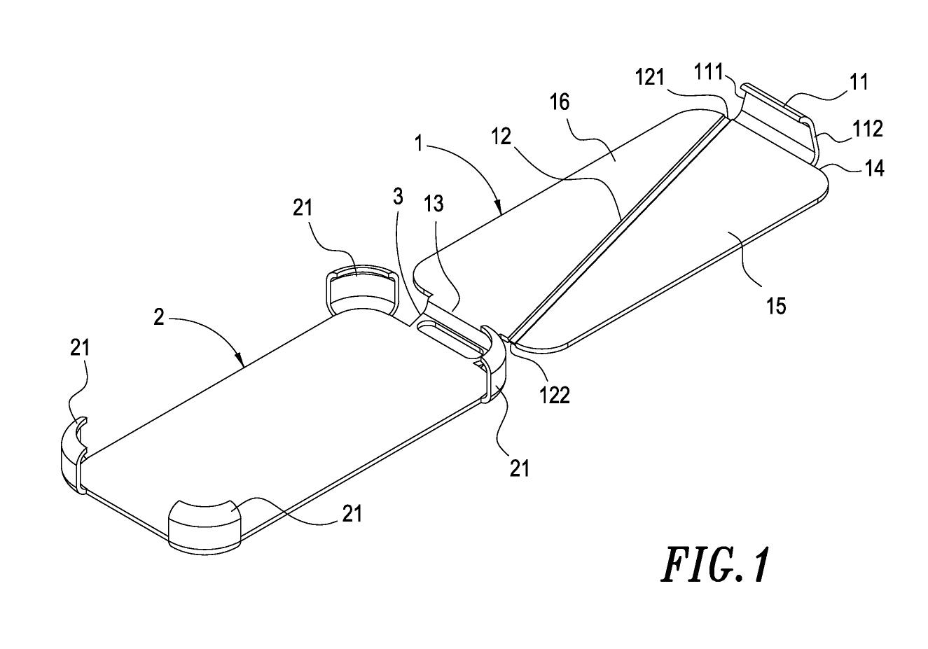

Referring to FIG. 1 which is a perspective view for the present invention of a mobile phone casing that has been unfolded and comprises:

A locating base 2 on which positioning measures are prepared for holding and positioning a mobile phone wherein the positioning measures are assigned to at least a clamping part 21 around the locating base 2 and are hook-and-loop fasteners or reused viscous bodies;

A cover body 1 comprising a first side edge 13, a second side edge 14, a fastening part 11 on the second side edge 14, a top edge 111 and a bottom edge 112 at the fastening part 11, an inclined folding line 12 between the first side edge 13 and the second side edge 14, and a first endpoint 121 as well as a second endpoint 122 at the inclined folding line 12 wherein the first endpoint 121 is higher than the top edge 111 of the fastening part 11 and near the second side edge 14 and the second endpoint 122 is lower than the bottom edge 112 of the fastening part 11 and near the first side edge 13 so that the cover body 1 is separated into a baseplate 15 and a support plate 16;

An attachment 3 linking the first side edge 13 of the cover body 1 and the locating base 2 as a whole.

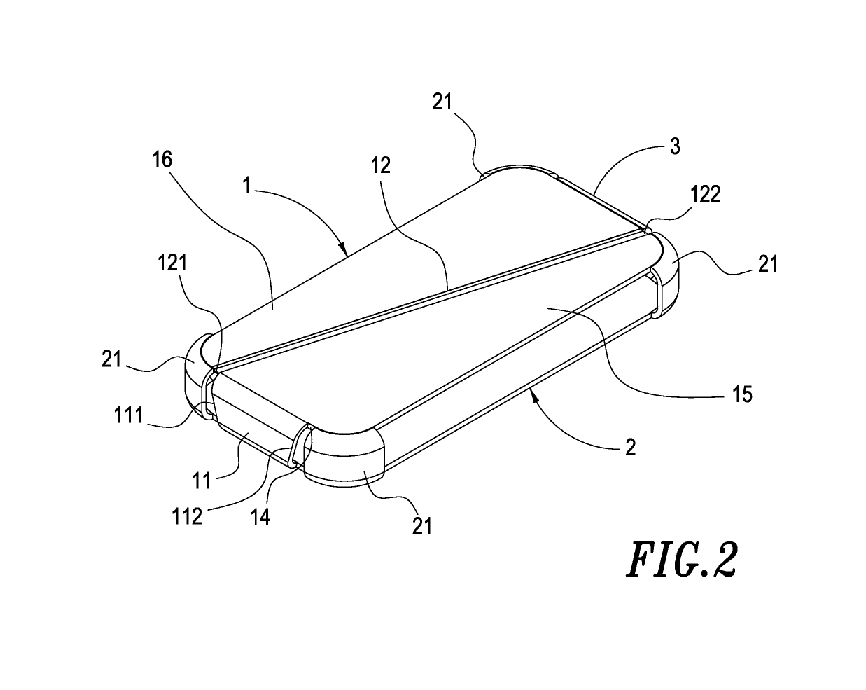

Referring to FIG. 2 which is a perspective view for the present invention of a mobile phone casing that has been folded. As shown in FIG. 2, the cover body 1 is able to exteriorly cover a mobile phone (not in FIG. 2) held and positioned in the locating base 2, making the mobile phone which has been buckled and positioned by a plurality of clamping parts 21 inseparable and laterally fixed by means of the fastening part 11 on the cover body 1, and effectively preventing an electronic device from collision or abrasion out of any external force.

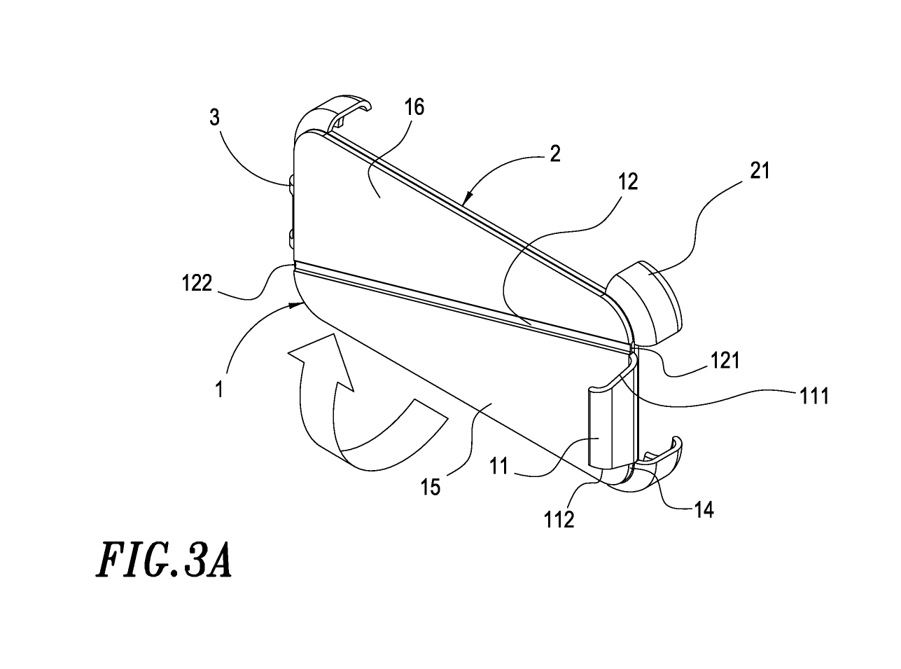

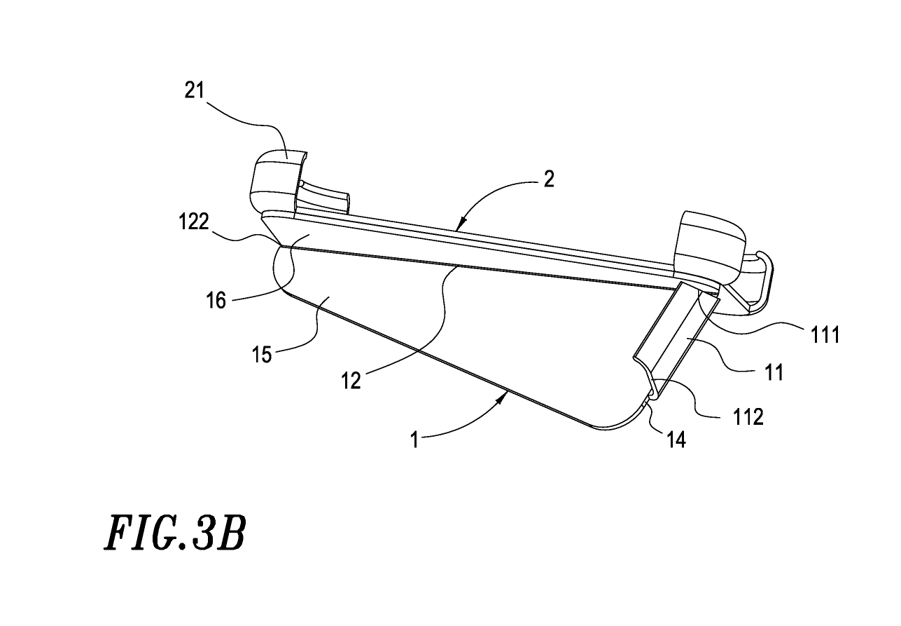

Referring to FIGS. 3A and 3B which are schematic views of the mobile phone casing in operation and illustrate the present invention with an electronic device held is tilted on a level table. As shown in FIG. 3A, the cover body 1 is lifted backward until the back of the locating base 2 and partially folded outward in virtue of the inclined folding line 12 on the cover body 1 for development of the baseplate 15 and the support plate 16 behind the locating base 2; the fastening part 11 of the cover body 1 laterally resists an edge of the locating base 2 (as shown in FIG. 3B) in order to securely support the locating base 2, tilting a mobile phone on a level table at a visible angle of elevation for observation of a user.

Furthermore, a mobile phone is also tilted at a visible angle of elevation when the locating base 2 is not laterally supported by the fastening part 11 of the cover body 1.

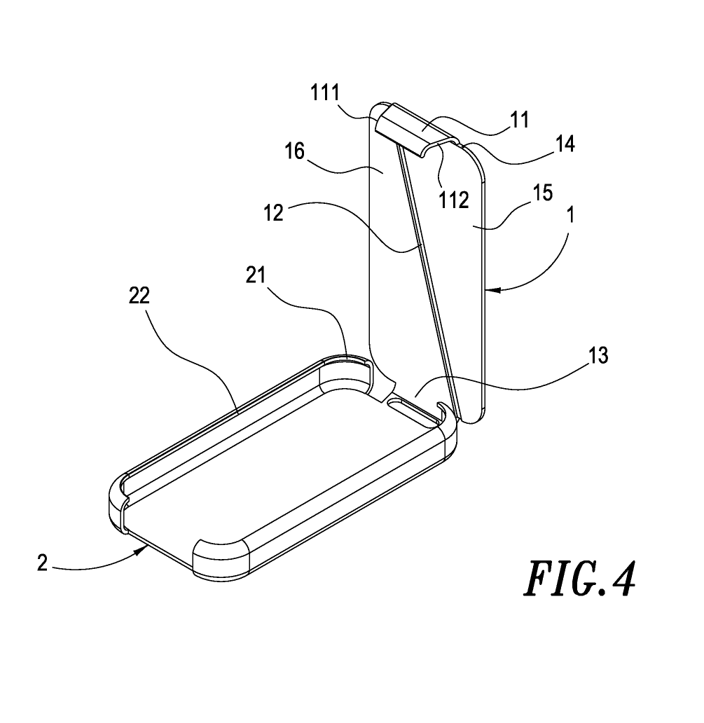

Referring to FIG. 4 which is a schematic view of the mobile phone casing in the other embodiment wherein the locating base 2 is provided with baffles 22 between the clamping parts 21 at both sides to reinforce an entire structure, effectively and externally protecting an electronic device, and realizing the mobile phone casing with better repellence.

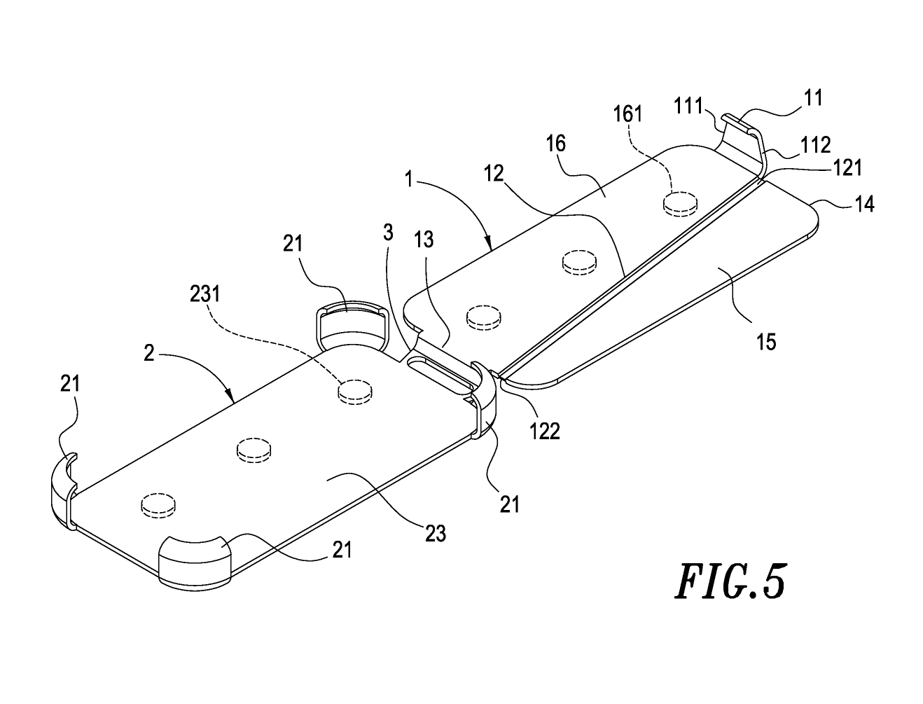

Referring to FIG. 5 which illustrates: both the first endpoint 121 and the second endpoint 122 of the inclined folding line 12 are lower than the bottom edge 112 of the fastening part 11; the first endpoint 121 must be higher than the second endpoint 122 in order to develop the inclined folding line 12; the inclined folding line 12 connecting the first endpoint 121 and the second endpoint 122 separates the cover body 1 into the baseplate 15 and the support plate 16.

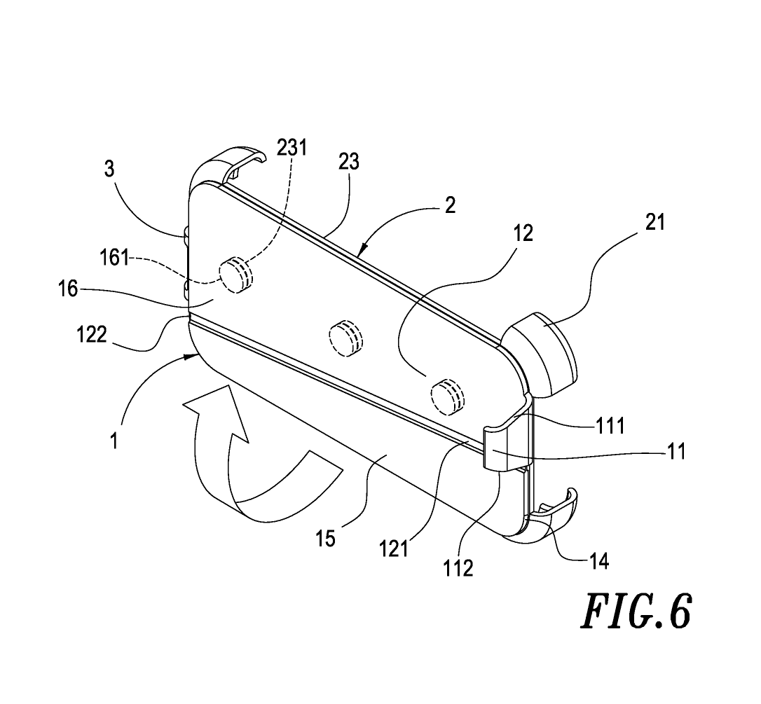

It can be seen from FIGS. 3A and 3B that the support plate 16 contacts or is separated from the locating plane 23 of the locating base 2 on which a mobile phone is held and positioned when the cover body 1 is lifted backward and located behind the locating base 2. As shown in FIG. 6, the support plate 16 is provided with at least a fixing component 161 which corresponds to at least another fixing component 231 on the locating plane 23 so that the support plate 16 is exactly opposite to the locating plane 23 by means of the fixing components 161, 231.

The fixing components 161, 231 hereinbefore can be magnets, hook-and-loop fasteners, fasteners or other fixing components which are not specifically defined herein.

As shown in FIG. 1 through FIG. 6, the first endpoint 121 and the second endpoint 122 of the inclined folding line 12 are located at two opposite sides.

The present invention of a mobile phone casing has advantages as follows:

1. The present invention provides a mobile phone casing with an inclined folding line developed on a cover body by which the cover body is partially folded outward so that the cover body's fastening part laterally resists the other part of the cover body in order to make an electronic device, which has been held in the present invention, tilted on a level table at a visible angle of elevation and observed by a consumer.

2. The present invention provides a mobile phone casing in which a mobile phone is held in order to prevent the mobile phone from collision or abrasion out of any external force.

3. The present invention provides a mobile phone casing with versatile characteristics such as simple structure, easy operation and high stability.

The above disclosures are preferred embodiments only which do not limit claims of the present invention; any equivalent embodiment or change out of a person skilled in the art without departing from the spirit and scope of the present invention should be incorporated in claims of the present invention.

What is claimed is:

1. A mobile phone casing, comprising:
A locating base on which positioning measures are prepared for holding and positioning a mobile phone;
A cover body provided with a first side edge, a second side edge, a fastening part on said second side edge, and a top edge as well as a bottom edge at said fastening part;
An attachment linking said first side edge of said cover body and said locating base as a whole;
Features:
Said cover body is designed to have an inclined folding line located between said first side edge and said second side edge and including a first endpoint and a second endpoint wherein said first endpoint is higher than a top edge of said fastening part and said second endpoint is lower than a bottom edge of said fastening part so that said cover body is separated into a baseplate and a support plate.

2. The mobile phone casing according to claim 1 wherein said first endpoint and said second endpoint of said inclined folding line are near said second side edge and said first side edge, respectively.

3. The mobile phone casing according to claim 1 wherein said positioning measures are assigned to at least a clamping part around said locating base.

4. The mobile phone casing according to claim 1 wherein said positioning measures can be hook-and-loop fasteners.

5. The mobile phone casing according to claim 1 wherein said positioning measures can be reused viscous bodies.

6. The mobile phone casing according to claim 1 wherein said support plate is provided with at least a fixing component corresponding to other fixing components on said locating plane of said locating base for holding and positioning a mobile phone.

7. A mobile phone casing, comprising:
A locating base on which positioning measures are prepared for holding and positioning a mobile phone;
A cover body provided with a first side edge, a second side edge, a fastening part on said second side edge, and a top edge as well as a bottom edge at said fastening part;
An attachment linking said first side edge of said cover body and said locating base as a whole;
Features:
Said cover body is designed to have an inclined folding line located between said first side edge and said second side edge and including a first endpoint and a second endpoint wherein both said first endpoint and said second endpoint are lower than a bottom edge of said fastening part and said first endpoint is higher than said second endpoint so that said cover body is separated into a baseplate and a support plate.

8. The mobile phone casing according to claim 7 wherein said first endpoint and said second endpoint of said inclined folding line are near said second side edge and said first side edge, respectively.

9. The mobile phone casing according to claim 7 wherein said positioning measures are assigned to at least a clamping part around said locating base and are hook-and-loop fasteners or reused viscous bodies.

10. The mobile phone casing according to claim 7 wherein said support plate is provided with fixing components corresponding to other fixing components on said locating plane of said locating base for holding and positioning a mobile phone.
